(19) United States
(12) Patent Application Publication
(10) Pub. No.: US 2003/0082259 A1
(43) Pub. Date: May 1, 2003

(54) Mold with means to compact and eject the molding

(76) Inventor: Tzung-Lung Lee, Shi-Chi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/985,109

(22) Filed: Nov. 1, 2001

(51) Int. Cl. B29C 69/00; B29C 45/40

(52) U.S. Cl. 425/356; 425/324.1; 425/444

(57) ABSTRACT

A mold includes a top die and a bottom die moved relative to each other and defining therebetween a cavity for molding a molding of predetermined pattern, and a compacting mechanism adapted to compact the molding in the cavity, the compacting mechanism having a plurality of compacting rods adapted to compact the molding in the cavity, a pressure plate adapted to move the compacting rods into the cavity to compact the molding in the cavity, and a plurality of stop rods adapted to limit the range of movement of the pressure plate toward the bottom die.

### BACKGROUND OF THE INVENTION

The present invention relates to a mold for injection molding and, more particularly to a mold with means to compact and eject the molding.

An ejection-molding machine is to melt plastic resins into molten material, and then to inject the molten material into a mold for molding into the desired molding. FIG. 1 shows a mold for this purpose. This structure of mold comprises an upper die 10a and a bottom die 11a. The upper die 10a has a molten material filling passage 12a in fluid communication with the cavity 13a defined between the upper die 10a and the bottom die 11a. During ejection molding, a driving mechanism is operated to close the upper die 10a and the bottom die 11a, and then the molten material is injected into the cavity 13a where the molten material is molded into the desired molding. Further, an ejector 14a is provided having an ejector rod 15a adapted to eject the molding out of the cavity 13a. After the molding process, the ejector rod 15a is moved into the cavity 13a to eject the molding out of the cavity 13a. This structure of mold is functional, however it has drawbacks. When injecting the molten material into the cavity 13a, air tends to be accumulated in the molten material inside the cavity 13a, causing the presence of bubbles in the molding.

### SUMMARY OF THE INVENTION

The present invention has been accomplished to provide a mold, which eliminates the aforesaid problem. It is one object of the present invention to provide a mold, which has means to compact the molding, preventing the formation of bubbles in the molding. It is another object of the present invention to provide a mold, which has means to eject the molding out of the cavity of the mold after the molding process. To achieve these and other objects of the present invention, the mold comprises a top die and a bottom die moved relative to each other and defining therebetween a cavity for molding a molding of predetermined pattern, and a compacting mechanism adapted to compact the molding in the cavity. The compacting mechanism comprises a plurality of compacting rods adapted to compact the molding in the cavity, a pressure plate adapted to move the compacting rods into the cavity to compact the molding in the cavity, and a plurality of stop rods adapted to limit the range of movement of the pressure plate toward the bottom die.

### BRIEF DESCRIPTION OF THE DRAWINGS

FIG. 1 is a sectional view of a mold constructed according to the prior art.

FIG. 2 is an elevational view of a mold with means to compact and eject the molding constructed according to the present invention.

FIG. 3 is an exploded view of the mold according to the present invention.

FIG. 4 is a top view of the mold according to the present invention.

FIG. 5 is a sectional view taken along line 5-5 of FIG. 4.

FIG. 6 is a sectional view taken along line 6-6 of FIG. 4

FIG. 7 is a sectional view of the present invention showing the compacting action of the mold.

FIG. 8 is a sectional view of the present invention showing the ejecting action of the mold.

FIG. 9 is a sectional view of an alternate form of the present invention.

FIG. 10 is a sectional view of another alternate form of the present invention.

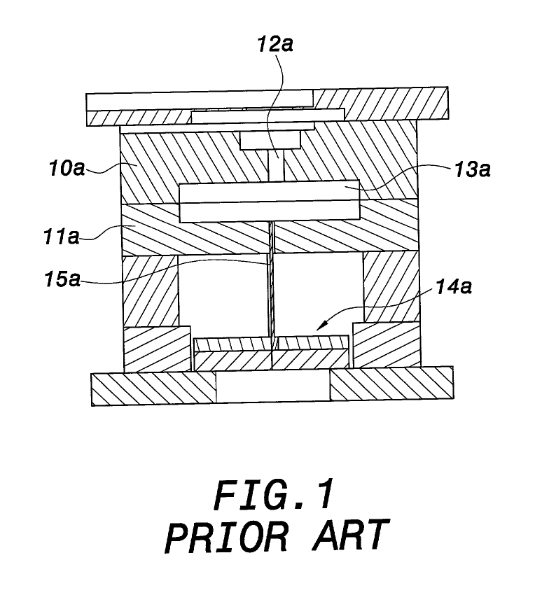

### DETAILED DESCRIPTION OF THE PREFERRED EMBODIMENT

Referring to FIGS. from 2 through 6, a mold is shown comprising an upper die 10 and a bottom die 11. The upper die 10 and the bottom die 11 define a cavity 13 of a predetermined pattern. The upper die 10 has a molten material filling passageway 12 in fluid communication with the cavity 13. A first locating plate 14 is fastened to the upper die 10. A driving mechanism (not shown) is operated to move the upper die 10 and the bottom die 11 toward each other, keeping the upper die 10 and the bottom die 11 in a close position. Molten plastic material is injected through the molten material filling passageway 12 into the cavity 13 for molding into a finished produce.

The mold further comprises a compacting mechanism 15. The compacting mechanism 15 is comprised of a pressure plate 16, a cover plate 19, a plurality of stop rods 17, and a plurality of compacting rods 32. The pressure plate 16 is a rectangular plate. The stop rods 17 are round rods respectively perpendicularly fastened to one side of the pressure plate 16 by screws 18 and aimed at the bottom die 11. By means of controlling the forward (compacting) stroke of the pressure plate 16, the stop rods 17 are moved to and stopped at one side of the bottom die 11. The cover plate 19 is covered on the pressure plate 16, having a plurality of through holes 20 for the passing of the stop rods 17 and the compacting rods 32. The compacting rods 32 are mounted in the pressure plate 16 in parallel to the stop rods 17, and can be inserted through the cover plate 19 and the bottom die 11 into the cavity 13 to compact the molding.

Two side racks 21 are provided at two sides of the compacting mechanism 15, and fixedly fastened to a locating plate 22. The pressure plate 16 with the stop rods 17 are disposed in the space surrounded by the side racks 21, the bottom die 11, and the locating plate 22. The locating plate 22 has a circular center through hole 23. A movable member 24 is inserted into the center through hole 23 of the locating plate 22, having a plurality of push rods 25 and a center through hole 26. A driving mechanism (not shown) is coupled to the movable member 24, and controlled to move the movable member 24 toward the pressure plate 16.

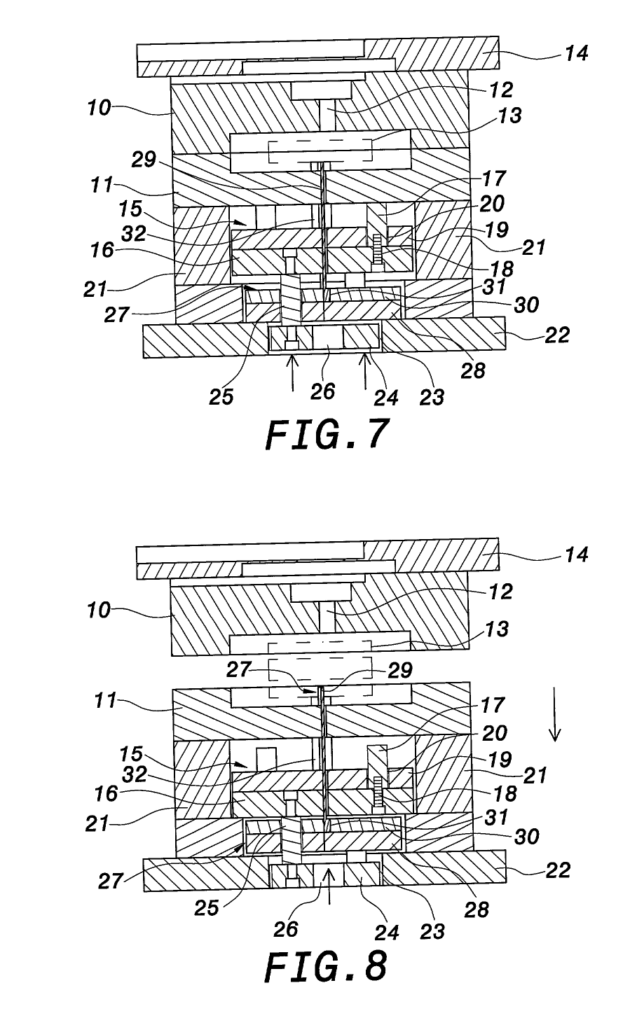

Referring to FIG. 7, after injection of molten material through the molten material filling passageway 12 into the cavity 13, the driving mechanism is operated to move the movable member 24 toward the pressure plate 16, causing the push rods 25 to force the pressure plate 16 and the stop rods 17 and the compacting rods 32 toward the bottom die 11. Moving the pressure plate 16 toward the bottom die 11 causes the compacting rods 32 to be inserted into the cavity 13 to compact the molding. When moving the pressure plate 16 forwards toward the bottom die 11, the stop rods 17 will be stopped against the bottom die 11 to limit the forward (compacting) stroke of the pressure plate 16. This compacting action eliminates the formation of bubbles in the molding.

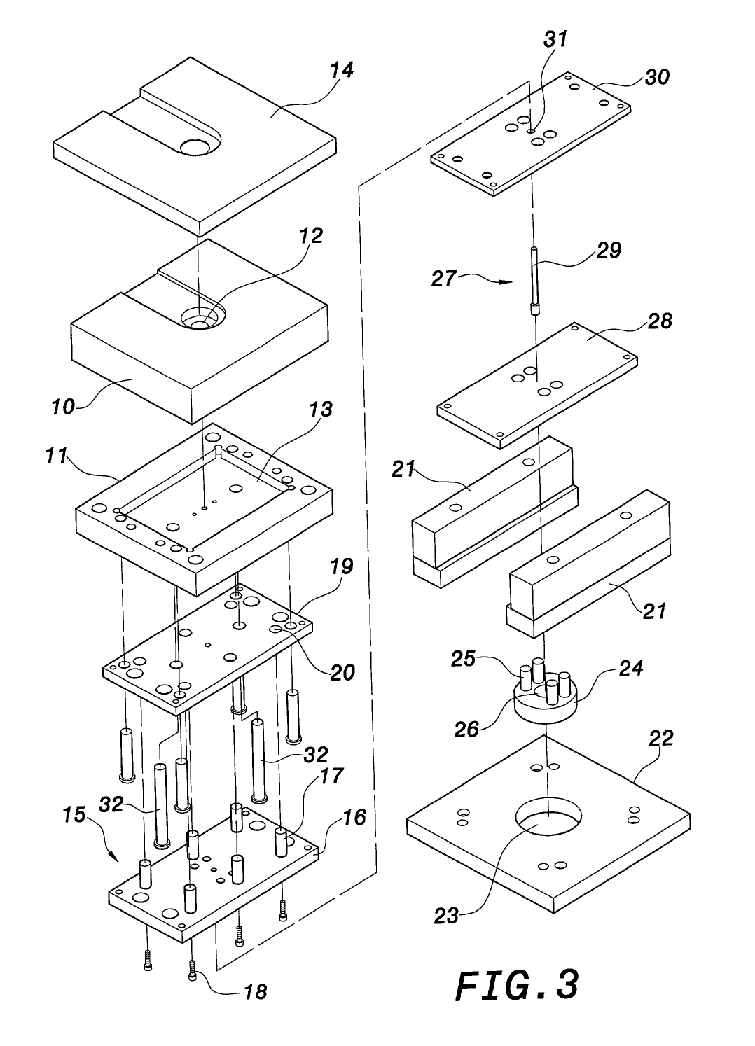

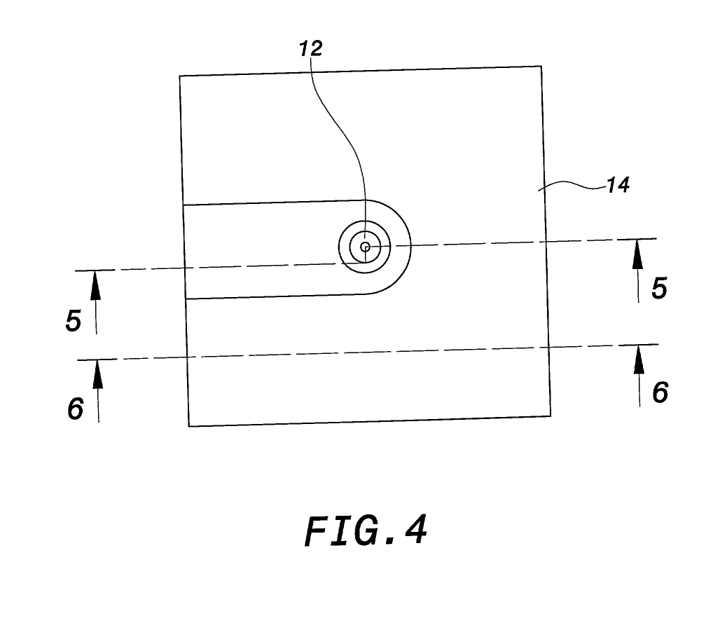

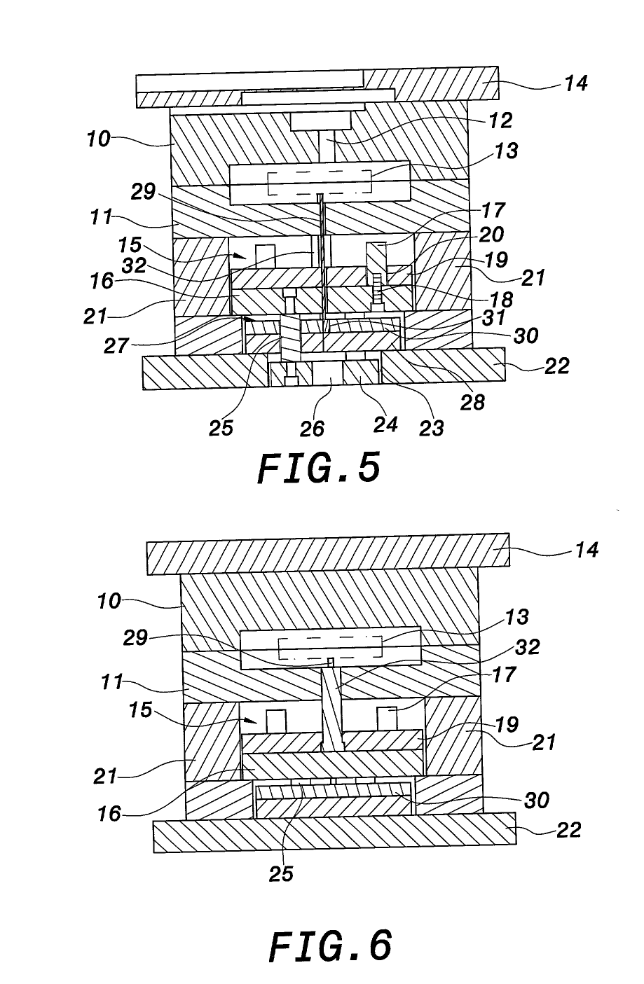

Referring to FIGS. 3 and 5, an ejector 27 is provided and controlled to eject the molding out of the cavity 13 after opening of the mold. The ejector 27 comprises a rectangular ejector plate 28 disposed between the locating plate 22 and the pressure plate 16, an ejecting rod 29 supported on the ejector plate 28 for insertion through the pressure plate 16, the cover plate 19 and the bottom die 11 into the cavity 13 to push the molding out of the cavity 13, and a cover plate 20 covered on the ejector plate 28. The cover plate 30 has a center through hole 31 for the passing of the ejector rod 29.

Referring to FIG. 8, after the formation of the desired molding in the cavity 13 and the action of compacting the molding, the top die 10 and the bottom die 11 are opened, and then the driving mechanism is operated to move the ejector plate 28 toward the bottom die 11, causing the ejector rod 29 to eject the molding out of the cavity 13.

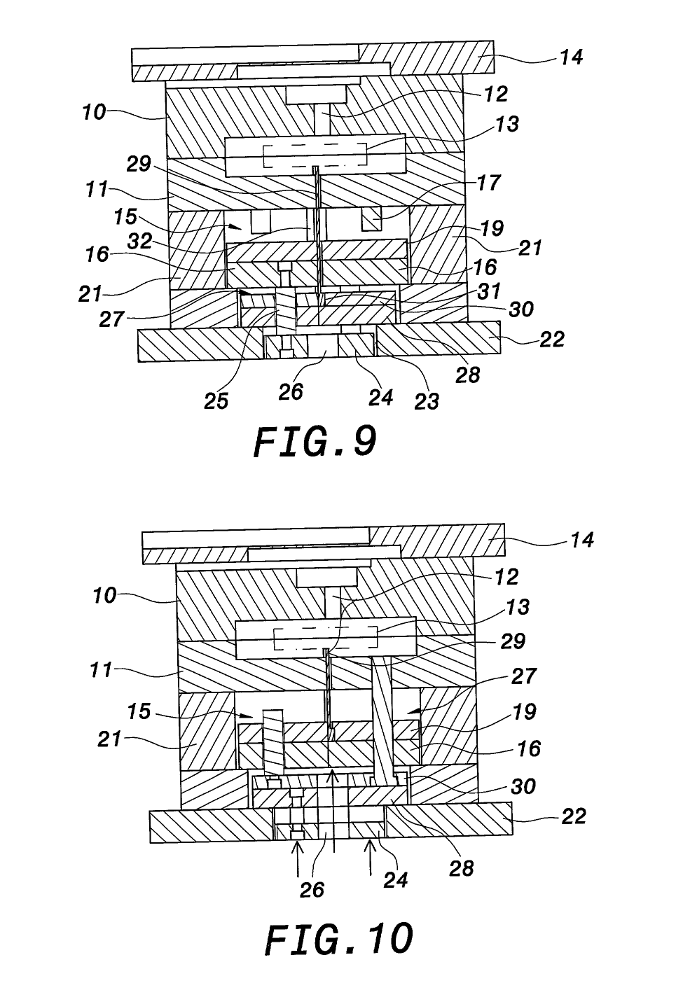

FIG. 9 shows an alternate form of the present invention. According to this alternate form, the stop rods 17 are fixedly mounted on the bottom sidewall of the bottom die 11 and adapted to limit the forward (compacting) stroke of the pressure plate 16.

FIG. 10 shows another alternate form of the present invention. According to this alternate form, the position of the compacting mechanism 15 and the position of ejector 27 are interchanged.

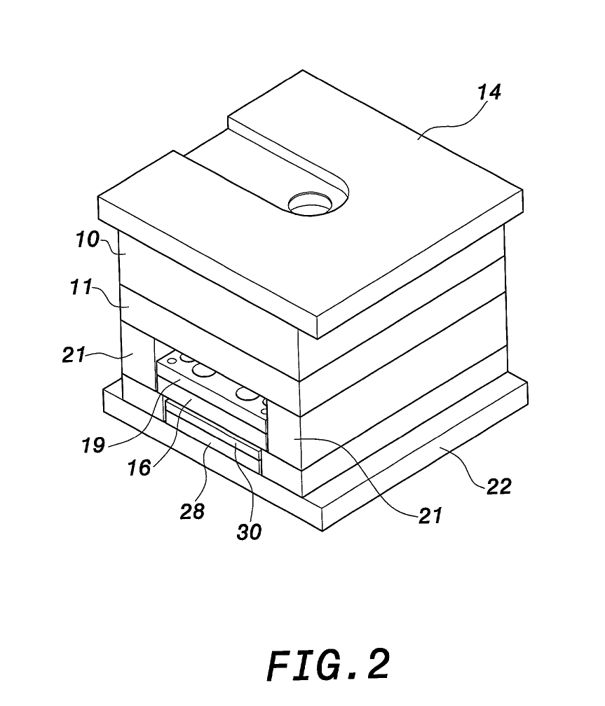

A prototype of mold with means to compact and eject the molding has been constructed with the features of the annexed drawings of FIGS. 2˜10. The mold with means to compact and eject the molding functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A mold comprising:
a top die and a bottom die moved relative to each other and defining therebetween a cavity for molding a molding of predetermined pattern; and
a compacting mechanism adapted to compact the molding in said cavity, said compacting mechanism comprising a plurality of compacting rods adapted to compact the molding in said cavity, a pressure plate adapted to move said compacting rods into said cavity to compact the molding in said cavity, and a plurality of stop rods adapted to limit the range of movement of said pressure plate toward said bottom die.

2. The mold as claimed in claim 1 wherein said stop rods are fixedly perpendicularly mounted on one side of said pressure plate and aimed at a bottom said of said bottom die.

3. The mold as claimed in claim 1 wherein said stop rods are fixedly perpendicularly mounted on a bottom sidewall of said bottom die and aimed at said pressure plate.

4. The mold as claimed in claim 1 wherein said compacting mechanism further comprising a cover plate covered on said pressure plate, said cover plate having through holes for the passing of said stop rods and said compacting rods.

5. The mold as claimed in claim 1 wherein said compacting mechanism further comprising a locating plate, said locating plate having a center through hole, two side racks fixedly fastened to said locating plate in parallel and defining with said locating plate and said bottom die a receiving space, which receives said pressure plate, said stop rods, and said compacting rods, a movable member coupled to a driving mechanism and driven to move in and out of the center through hole of said locating plate and adapted to move said pressure plate toward said bottom die, said movable member having a plurality of push rods stopped against one side of said pressure plate opposite to said compacting rods.

6. The mold as claimed in claim 1 further comprising an ejector comprised of an ejector rod adapted to eject the molding out of said cavity, and an ejector plate adapted to move said ejector rod into said cavity to eject the molding out of said cavity.
